(19) United States
(12) Patent Application Publication
(10) Pub. No.: US 2004/0158860 A1
(43) Pub. Date: Aug. 12, 2004

(54) Digital music jukebox

(75) Inventor: William M. Crow, Sequim, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA (US)

(21) Appl. No.: 10/360,281

(22) Filed: Feb. 7, 2003

(51) Int. Cl. H04N 7/173; H04N 7/025; H04N 7/10; H04N 5/445; G06F 3/00

(52) U.S. Cl. 725/46; 725/86; 725/87

(57) ABSTRACT

A music content delivery service utilizes a broadcast medium to provide the hardware and infrastructure that is used for digital television services. The service permits the digital music content to be segregated, stored and/or played back on one or more client systems in various forms, such as personalized streaming music content or a creation of a personalized music jukebox.

### FIELD OF THE INVENTION

The present invention generally relates to delivering music services, and more particularly, the invention relates to delivering music content through a broadcast medium and selectively filtering and/or storing the content at a client system.

### BACKGROUND OF THE INVENTION

The personal computer and Internet have enabled new possibilities for digital music delivery. However, current attempts to provide digital music via the Internet suffer from a variety of technical and business shortcomings. For example, these services typically require a broadband Internet connection for sufficient bandwidth. However, the cost, difficulty to provision, and unpredictable quality of broadband service significantly reduces the potential market size. The variety of different PC solutions currently presents a confusing landscape. Most choices still require proper installation and configuration of software and audio peripherals.

The protection of distribution rights for such content is also a genuine concern. This has led to a confusing array of digital rights management solutions. These solutions significantly detract from the usability of available and practical music content delivery.

Thus, while the power and flexibility of the PC have enabled potential new digital music services, it is doubtful that most customers will use the PC as a first choice for music listening. The purchase of a PC and broadband service must typically be cost-justified for reasons other than subscription to a digital music service. It is not an acceptable value proposition to purchase a PC and/or broadband Internet service simply to obtain access to digital music content.

### SUMMARY OF THE INVENTION

The present invention overcomes the shortcomings in currently known music content delivery services by delivering a variety of music services through a shared broadcast medium, such as a digital broadcast television infrastructure. In one embodiment, music content and/or services are delivered to one or more client systems as a digital music content stream via a shared broadcast delivery network. The client system filters and stores the received content based on certain criteria obtained from client system users or from other sources. In one aspect of the invention, the client system provides a user interface on a television or similar video display device to permit users to play back the received music content in various operable modes.

The invention is operable to filter and store the music content in various ways. For example, the invention operates in one mode to provide personalized streaming music to listeners. In this mode, the listener receives the music content with no particular predetermined play list, and limited options control the specific music offerings and their order of play. In another mode, the invention provides a personalized jukebox in which the customer's music listening preferences are used to populate an electronic storage medium. This mode enables the listener to create personalized play-lists for song titles stored in the jukebox, and to select various song titles stored in the jukebox for playback.

In yet another alternative mode of operation, the invention provides a personal music collection. The customer may select and manage received content that is stored locally and rendered available for playback. In this mode, a user interface integrates digital music content already stored by the customer, such as that accessible via other network-connected devices.

### BRIEF DESCRIPTION OF THE DRAWINGS

FIG. 1 is a block diagram representation of a client-server system according to one embodiment of the present invention;

FIG. 2 is a block diagram representation of the server of FIG. 1 shown in greater detail;

FIG. 3 is a block diagram representation of the client of FIG. 1 shown in greater detail;

FIGS. 4a-4c are flow charts illustrating certain functions of an application executing on the client system shown in FIGS. 1-3 according to one embodiment of the invention;

FIG. 5 illustrates one possible user interface for providing streaming music content to a listener according to the invention;

FIG. 6 illustrates another user interface that provides a playlist of music titles; and

FIG. 7 illustrates a user interface similar to that of FIG. 6 for providing access to a personalized music collection listing.

### DETAILED DESCRIPTION OF THE INVENTION

This invention relates to delivering music content and related services over a broadcast network to one or more client systems. The invention provides a variety of music exploration, listening and purchasing services. The delivered content is preferably tagged in some manner so that it may be filtered and then selectively stored by the client system locally according to user preferences or other criteria. By filtering a shared broadcast in this manner, the invention extends Internet-based music services to an advanced digital set-top box environment. The invention also preferably provides a user interface that permits informed choices of available music selections or enables other decision making as desired.

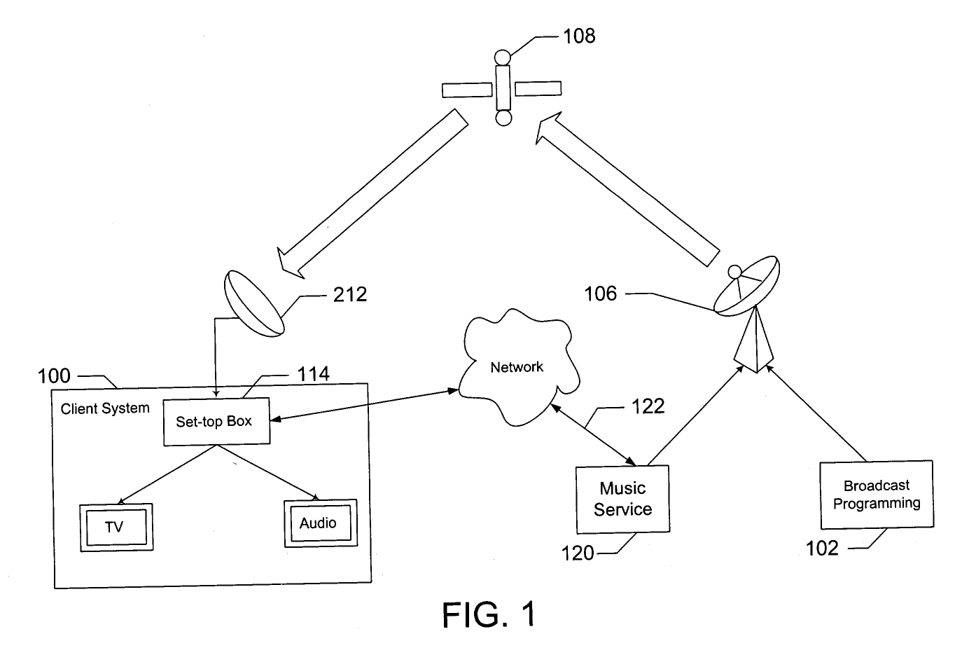

FIG. 1 illustrates a block diagram representation of a client-server system 100 according to the invention. In this embodiment, the invention is implemented as part of a digital satellite network that provides broadcast television and audio programming, and optionally other information over data broadcast channels. For example, as described in related application Ser. No. 09/903,973, filed on Jul. 12, 2001, the subject matter of which is incorporated herein by reference in its entirety, the network preferably supplies digital music content in a broadcast channel in the allocated bandwidth. The network also provides other types of television programming and content.

The digital satellite broadcast system in FIG. 1, denoted by the functional block 102, provides digital music and other services broadcast to one or more Client Systems such as a Client System 100. In particular, the available television programming is up-linked via a transmitter 106 to the satellite system 108 over a first communication channel. The programming is down-linked via a second data communication channel to a plurality of Client Systems, one of which is shown as Client System 100. The Client System includes receiver 112 that is coupled with a set-top box 114 or other similar computing device adapted to capture the programming as is understood by those skilled in the art.

Digital broadcast music content is provided over the broadcast network via a Music Service, denoted by a block 120 in FIG. 1. As with the television programming, the digital satellite system broadcasts such music content. The digital music content is sometimes compressed and transmitted over fairly low bandwidth data channels allocated by the broadcast satellite system. In one example, multiple digital audio channels are dedicated to music delivery such as of a particular genre.

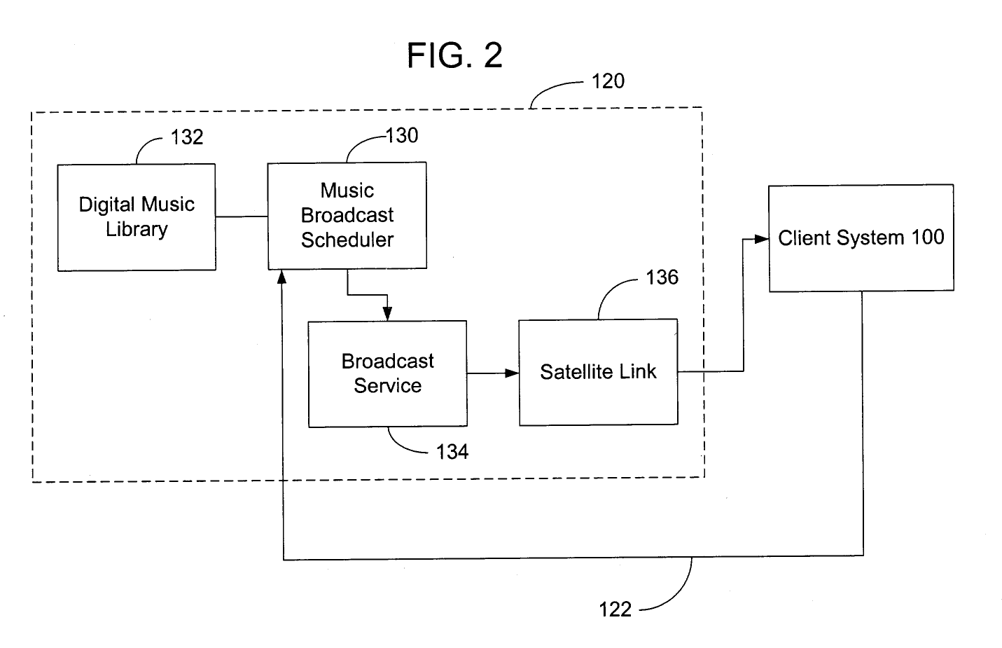

As shown in FIGS. 1 and 2, the Music Service 120 is connected to the Client Systems through a Wide Area Network communication channel 122. The communication channel 122 is preferably used as a back-channel to enable communication between the Client System 100 and the Music Service 120. In this way, the Music Service may obtain data concerning user listening and purchasing preferences. Likewise, the Client Systems may initiate requests for Internet services such as requests to purchase various music titles or albums. Data concerning the programming currently being broadcast may be retrieved from the Internet from the Music Service or from other sources and provided to the user as well. Such data may permit the user to connect to a related web site to obtain relevant information concerning the broadcast. The operation of the music services does not require either a broadband or a continuously connected Internet connection. Combined with the broadcast music content, a periodic background connection employing a more conventional low-speed dial-up connection is sufficient to support the music services described in this invention.

While the invention is described in the context of a digital satellite system, such music content may alternatively be delivered via a cable television system. For example, the content may be supplied via a digital cable system that delivers multiple channels of video data in a compressed format, such as MPEG II format. In this embodiment, the cable provider typically allocates dedicated channels for transmission of compressed digital audio content. Other broadcast systems may be used to deliver the services to various users. Thus, broadcast programming may be provided through either (or both) a satellite link or through a network/cable system. Advantageously, use of a broadcast system permits carouselled music to be downloaded to enable substantially regular refresh of different music titles at the Client System. In addition, such content may be obtained when the resources of the Client System, such as the digital tuner(s) of a set-top box, are not being utilized. As explained below, distribution of music content in this manner provides enhanced security as compared to distribution of music content via the Internet.

For delivering digital music content, a Music Service 120 selects the music content that is delivered to the Client Systems. The details of the Music Service are shown in FIG. 2. The principle components include a Music Broadcast Scheduler 130, implemented as a process that performs various tasks. As shown in FIG. 2, the Music Broadcast Scheduler 130 accesses a Digital Music Library 132, in this case a data store located at the Music Service or elsewhere. The Digital Music Library 132 is a repository of music content, and typically contains records that are associated with indices to permit tagging of the various music titles. The Broadcast Scheduler 130 also obtains information from the various Client Systems such as Client System 100 via the WAN connection 122 shown in FIG. 2. The Broadcast Scheduler 130 sometimes uses this information to decide what content will be transmitted by the service. Alternatively or in addition to the feedback provided by listeners, the Broadcast Scheduler 130 may distribute music content based on many other determinations as desired by the service provider.

The particular music titles are preferably indexed through the use of a Unique Identifier or Event ID. Each of the music titles is also tagged with some or all of the following information: (1) a Unique Artist ID; (2) a Unique Album ID; (3) a CD/Artist information package; (4) a Genre ID; (5) an Original Release Date; (5) a “Sounds Like” tag; and (5) a “New Song” flag, such as a song that is currently promoted by the artist's label. This permits the Client System to perform intelligent filtering and other processing of music content transmitted thereto.

The Broadcast Scheduler 130 provides the content to a Broadcast Service component, denoted by a block 134. This component aggregates and normalizes the various content streams that will be broadcast over the shared pipe. For example, the Broadcast Service 134 creates a normalized data stream that includes an Event Identifier associated with each music title or meta-data provided by external music service providers. For a 2.5 Mbs satellite data channel dedicated for delivery of music content compressed at a data rate of 128 Kbs, the service can deliver up to 300 songs per hour, or 7200 songs per day. With carouselled scheduling, and more frequent broadcast of the most popular content, the service can deliver over 2,500 unique songs per day. With a media encoder that produces “CD quality” content at a lower data rate, such as at 64 Kbs, the download bandwidth and storage requirements may be reduced, or the broadcast content and effective local library size increased.

Such information is transmitted to a Client System where it is collected and selectively filtered by the Client System. This permits one or more playback modes such as a streaming music player mode, storage and playback of a personalized jukebox and/or creation of a personalized music collection.

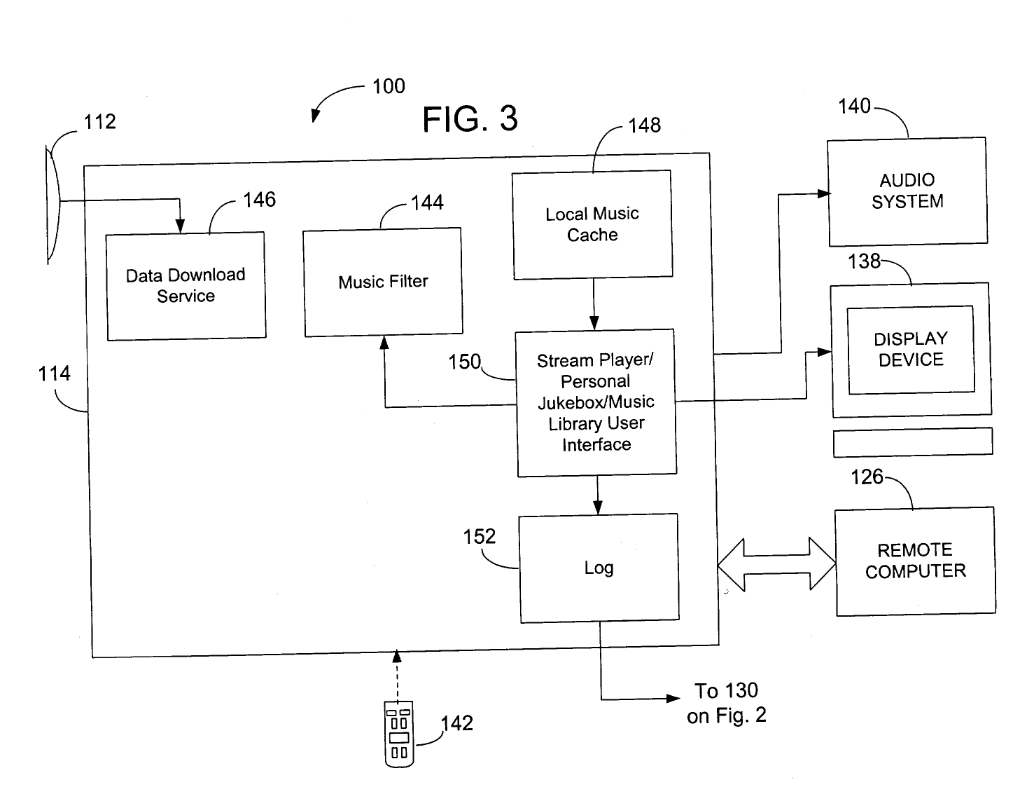

FIG. 3 is a block diagram representation of an exemplary Client System 100. Certain components and functionality of the Client System in FIG. 3 are not shown for purposes of clarity, but those skilled in the art will appreciate that the particular illustrated embodiment typically also includes such items as are required to receive and process broadcast television programming. The Client System 100 is implemented as a set-top box in the preferred embodiment, but it may alternatively be a personal computer, a video game console, or other embedded computing device configured to receive broadcast television programming and/or other services. While not shown, those skilled in the art should appreciate that the Client System 100 may include advanced features such as two or more digital tuners for receiving digital music content, satellite television programming and/or enhanced content. The Client System 100 also may include advanced digital-video-recording (“DVR”) capabilities. A portion of the DVR storage media is allocated to the music service to enable storage of the delivered music content in various modes, as explained below. The Client System 100 facilitates audio and video navigation and playback, as well as Internet navigation. However, while these features are advantageous, many client systems may be utilized to implement the invention, such as a personal computer, cellular telephone, video game console, personal digital assistant (PDA), or other embedded computer device.

The Client System 100 provides output video to a display device 138. The display device 138 may be implemented as a high definition television display, a standard television display, a computer monitor, or other device capable of displaying text, animation, images or video represented by text, animation, image or video data. The Client System is also coupled with an audio system 140. The audio system 140 represents a speaker, stereo system, or a device capable of presenting sound represented by sound data.

In addition to providing output information, the Client System receives input information from a remote control device 142. As explained below, a listener typically uses the device 142 to select or input information concerning user preferences, to purchase music content and for inputting other requests to the Client System. A Music Filter component 144 uses such input information in order to determine whether to store the content broadcast to the Client System 100 and/or the Music Broadcast Scheduler uses such input information to optimize the content of scheduling of music programming broadcast to all Client Systems.

The Client System 100 typically communicates with other remote computers such as computer 126 as will be understood by those skilled in the art. Communication over a Local Area Network is facilitated by any appropriate means for establishing such communication, such as through a persistent, broadband IP network connection or by using any other available communication medium. The connection may be external to the set-top box, or implemented as an internal device. Also, the set-top box may include an external bus connection, such as a USB bus connection, for allowing connection of additional peripherals, including connection to a broadband network.

For receiving the various music titles and other content, a Data Download Service component 146 collects the transmitted music content. In one preferred embodiment, the Download Service 146 tunes to an appropriate digital music download transponder and Program ID filter as will be understood by those skilled in the art. At the start of a next downloaded song package, the Download Service 146 begins to transfer the song package into a local cache directory. In the event that the tuner is requested for another application (such as for PIP display or background digital recording in the case of a digital television system), the Download Service 146 relinquishes control of the tuner, and discards any partially cached content related thereto. The Download Service 146 then waits for a tuner to become available to begin a next download.

The Data Download Service component 146 also wakes the other software pieces when the content arrives at the Client System 100, including a Music Filter component 144. The latter performs filtering of the content received by the Data Download Service 146. That is, the Music Filter component 144 obtains the indices uniquely associated with each of the received music titles or other music content and decides which items will be stored on a Local Music Cache 148. Based on the tagged header information described above, the Music Filter Component 144 decides whether the particular content and any associated files should be saved. If not, the Filter Component 144 informs the Download Service 146 to stop writing data to the cache, discards any received data concerning the song package, and continues to scan for the beginning of the next song package.

On the other hand, when the song package should be saved, the Music Filter component 144 identifies any content in the music library (shown in FIG. 3 as Local Music Cache 148) that may need to be discarded to make room for the new content, and deletes all associated files. Then, the Music Filter component 144 transfers the downloaded sound data package to the appropriate library directory locations, and local databases are updated accordingly. In the meantime, the Data Download Service 146 begins to receive a next song data package and the process continues.

For performing the filtering function, the Music Filter component 144 may perform algorithms based on determinations of matching with a set of listener preferences, television viewing characteristics (such as viewing MTV instead of other channels) and/or based on purchasing options. As explained below, such preferences are obtained from feedback information such as rating information, artist, genre, “sounds like” and other information.

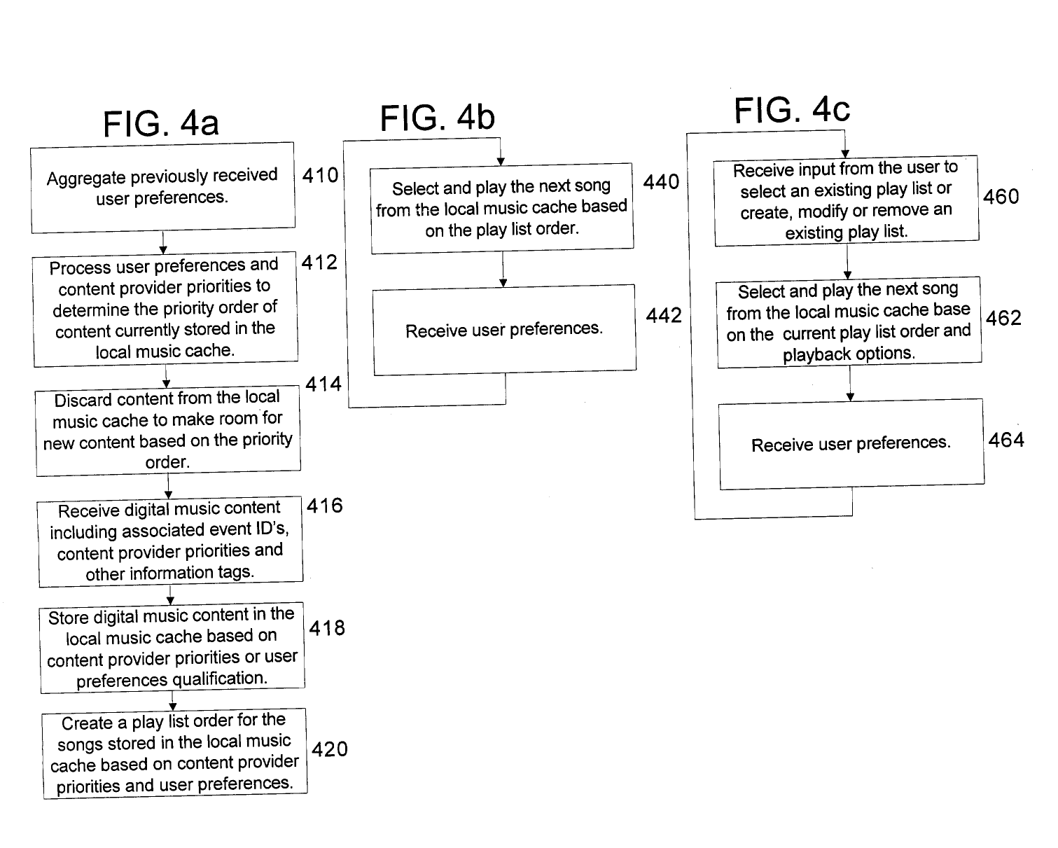

The Client System 100 operates in various modes. The various steps performed by the Client System to collect the downloaded content to support these operating modes are shown in FIG. 4a. In one mode, the Client System provides personalized streaming music in which the content is played with no pre-announced playlist. In this mode, the listener has limited options over the specific song titles or their order of play. The various steps performed by the Stream Player interface 150 for this mode is shown in FIG. 4b. In another mode, the user is allowed to control the order of music content playback, and create and organize personalized lists of individual songs that control the sequencing of playback. The sequence of operations performed by the Stream Player interface for this mode is shown in FIG. 4c.

Listening preference inputs previously provided by the user via the remote control device 142 or other suitable means when listening to music are aggregated for the purpose of filtering downloaded music content, as shown in step 410. This input can include likes or dislikes as expressed via a rating system for any particular song, artist or genre of music. The aggregation in step 410 combines recently received user input with previous input and updates a list of specific songs, artists and genres. It also identifies patterns in the feedback to infer additional filter criteria. For example, if the user indicates dislikes for multiple artists that are in the same genre, and also indicates no likes for any other artists within that genre, the aggregation process might infer a dislike for the entire genre. Step 412 describes the process of combining the user preferences with content provider priorities and other logic implemented in the Client System to determine an overall priority order for the playback of music form the local music cache. Content (provider priorities may indicate a preference to feature certain artists, or it may specify acceptable and unacceptable songs to play immediately following each specific song. In addition, the Client System maintains a record of song playback frequency, to insure all songs in the local music cache are played unless otherwise dictated by the user preferences and the content provider priorities. In anticipation of receiving new music content from the Broadcast Service 134 via the Data Download Service 146, the Client System discards the lowest priority content from the local music cache as shown in step 414. The total number of songs to be discarded to make room for new content is variable, and can be defined as part of the content provider preferences regularly downloaded to the Client System. In practice in a typical implementation, hundreds of songs can be deleted and replaced on a daily basis. As new music content is received, the Music Filter 144 evaluates each song's associated event ID's based on the user preferences and the content provider priorities to determine the priority for the song, as shown in step 416. If the song is not already present, is of an acceptable priority, and there is sufficient space, the song is stored in the local music cache, as shown in step 418. When the local music cache is full or the content download is complete, the Client System creates a new play list based on the user preferences, the content provider priorities, and the Client System record of song playback frequency. This is shown in step 420.

When the user chooses to listen to music using the personalized streaming music mode, step 440 describes the process for the Stream Player User Interface 150 to select and play the next song from the play list that was created in step 420. As the user listens to music, input can be provided via the remote control device 142 or other suitable means indicating a variable degree of like or dislike for the currently playing song, artist, or music genre, as shown in step 442. The Stream Player User Interface collects this input to reprioritize the content in the local music cache. In response to an input indicating strong dislike by the user, is possible for the Stream Player User Interface to dynamically reprioritize the content and, if allowed by the content provider preferences, even stop playing the current song and skip to the next song in the play list.

If the client system allows the user may select a personal jukebox mode of music playback. In this mode, the Music Library User Interface 150 accepts input from the user via the remote control 142 or another suitable means to create, modify and remove personalized play lists of songs from the local music cache, as shown in step 460. By including a song in a personalized play list, the Music Filter would be prevented from removing this song from the local music cache to make room for new downloaded content. The user can then select a personalized play list to control the sequence of the song playback. As shown in step 462, the Personal Jukebox User Interface selects the next song in the user selected play list and plays that song. Additional user controlled playback options determine if the next song is selected randomly or sequentially from the play list, and if when all songs in the play list have been played, whether playback stops or repeats. The user can continue to provide input as shown in step 464 to select a different play list or change the playback options.

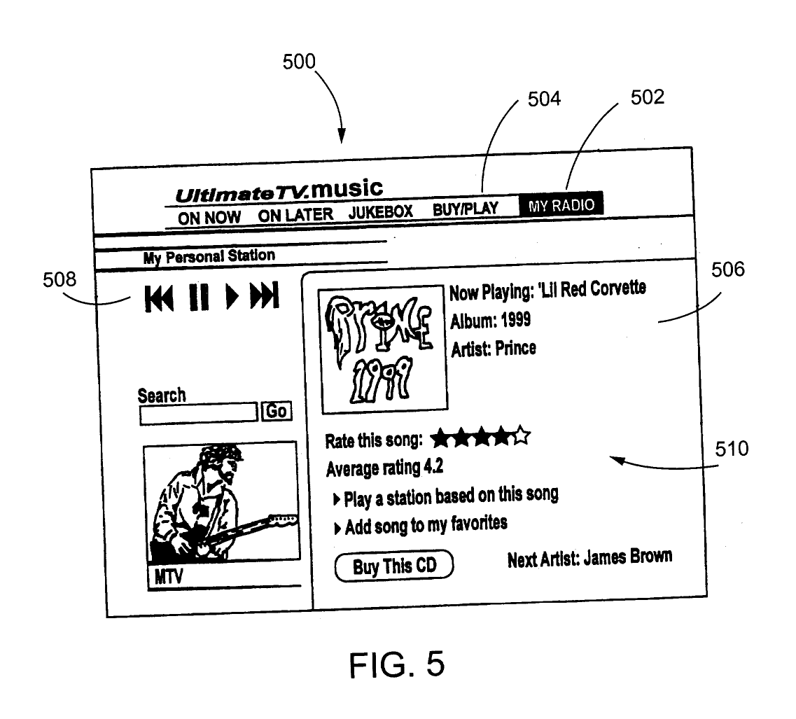

An exemplary Stream Player User Interface 500 is shown in FIG. 5. The Stream Player UI forms part of a Music Service interface that provides various services to listeners, as described in co-pending patent application Ser. No. 10/052,111, filed on Jan. 17, 2002, the subject matter of which is incorporated herein by reference in its entirety. Thus, in the embodiment of FIG. 5, the listener has selected a “My Radio” button 502 in a coarse navigation bar 504. The Stream Player UI presents a “Now Playing” display area 506 on the screen of a display device. This display area optionally includes artwork and relevant information concerning the currently playing title.

In accordance with one feature of the invention, the Stream Player UI presents certain options that are selectable by the listener, usually by highlighting a relevant portion of the screen display. For example, icons sometimes permit the listener to navigate through the music titles. These include Fast Forward or Rewind, as shown in the display area 508. Alternatively or in addition, the UI may include icons indicating a rating bar as shown at a display area 510. This icon permits the listener to rate the music title on a sliding scale. The UI provides the listener with other options concerning user preference input. The listener may choose to play a similar digital audio station and/or to add the song to a play list of favorites in the display area 510. The UI further permits the listener to purchase the CD, and informs the listener of the next artist.

Other optional personalization features include selection of music titles from the same era, inclusion of more or less songs from the same artist, and/or inclusion of more or less songs from similar artists. In addition, the UI may permit the listener to explore additional information concerning the artist and/or CD for the song. For example, the listener may obtain graphics concerning CD cover art, a CD track list, CD review, artist profile, artist discography, artist tour information and the like.

Thus, when the listener selects one or more preferences or options, the UI passes such information to the Music Filter 144 and possibly to the Music Broadcast Scheduler 130, via a log 152 maintained by the Client System. In this way, the system tailors the content that will be cached on the Client System 100 and maintained as a local library of music tracks for playback on demand, either via a blind play-list or under user control such as in a Personal Jukebox embodiment described below.

In the Personal Jukebox embodiment, the listener's music listening preferences are used to populate entries in a Personal Jukebox of music title selections. Preferably, the Personal Jukebox is initially populated in the same manner as in the Stream Player example described above with respect to identifying and storing song data packages that are received through the broadcast pipe. Unlike the Stream Player, however, the Client System 100 employs a Personal Jukebox User Interface, denoted by the block 150. In one embodiment, the listener does not directly control the content of the jukebox to provide content suppliers with ability to ensure that the consumer will make a purchase if they like the music. However, the listener can obtain direct access to any song currently stored in the Local Music Cache for play back, and to create personal play-lists to control the play order. Alternatively, the listener may create arbitrary play lists of their choice. Preferably, the Jukebox content is refreshed on a regular basis in accordance with listener preferences and actual playback choices.

As with the personalized streaming music, content partners may use the Personal Jukebox to target new content to the appropriate audiences and to gather valuable data concerning music listening habits. The charge for the Jukebox service could be based on the total jukebox storage capacity, the breadth of potential content available, and the listener's ability to prevent a portion of the jukebox content from being replaced. In this embodiment, the listener may be able to subscribe to different levels of service which would allow the listener to secure portions of the jukebox content from deletion. The subscription may define a number of songs (or other media) and the subscription may define a length of time the subscriber can retain songs (or other media) Therefore, one unique feature of the Personal Jukebox is that the songs are pre-populated in the Jukebox without direct user involvement, the songs are changed without direct user involvement, but the user has complete control over the media that is stored in the Jukebox while it is in the Jukebox. To gain control over the media, the user pays a fee.

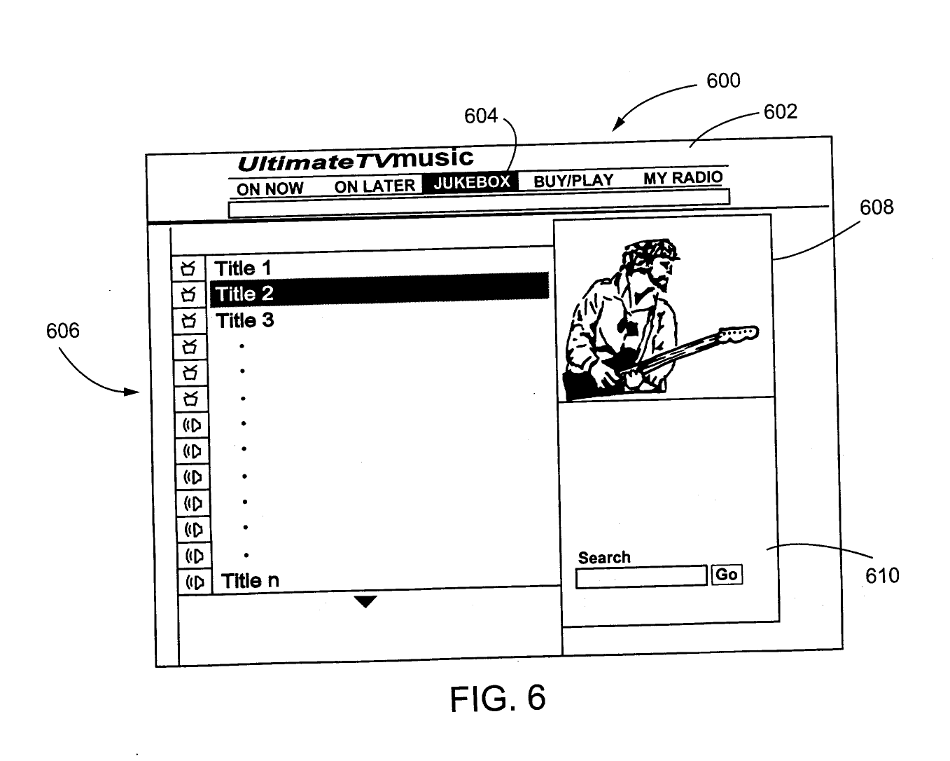

FIG. 6 illustrates an exemplary Personal Jukebox UI 600. This UI includes a play list of available music titles that may be selected for playback. As with the Streaming Player UI, a listener accesses the Jukebox UI selection button 604 via a coarse navigation bar 602. A play-list of music titles maintained in the personalized jukebox is maintained in a first display area 606. Thus, when the listener selects one of the items in the play-list, the system plays back the corresponding music track from storage. The items are added to the play-list based on user selection. Any number of play-lists can be created, edited or deleted as desired. Other information concerning the item currently being played back, such as album artwork or the like, may be provided in a display area 608.

Also, the Jukebox UI may include a search tool, shown in a display area 610, to permit listener access to items in the play list that are not currently being displayed. The search tool may optionally permit the listener to browse the stored content based on various parameters, including artist, genre, release date, play-list, or personal rating.

The same options and controls that are available with the Stream Player UI may also available with the Personal Jukebox. These include options to explore additional information about the song being played, to order the CD or related products, and to customize the received content updates for the Personal Jukebox based on ratings and other information concerning the currently playing song.

In one embodiment, the Personal Jukebox is configured to store approximately 400 songs in the Local Music Cache 148, which in this case is an allocated portion of the hard drive used for Digital Video Recorder (DVR) functionality. The service attempts to update a certain percentage (10 percent in this example) of the locally stored content on a periodic basis. The changeable content stored in the Personal Jukebox, then, is entirely refreshed at least once every two weeks. A portion of the Jukebox, however, may be configurable with a “Keep Until” setting to allow the listener to control whether certain songs are replaced. The remainder of the Jukebox is always available for refresh with new content.

In yet another alternative embodiment, the invention provides a personalized music collection in which the customer selects and manages the exact content to be stored locally and made available for playback. In this mode, an application that presents a Music Library User Interface, denoted by the block 150, maintains a record of the listener's purchases. In accordance with one optional feature, the Music Library application may refresh the Local Music Cache when a purchased song package is destroyed. To do this, the Music Library informs the Music Service that the purchased copy was destroyed by communicating a message to the Music Server via the back-channel. In response, the service may supply an additional copy of the purchased music title over a dedicated channel or tag the song data package and supply it over the broadcast channel. The song data package is then retrieved as described above. In addition, a user interface provides access to content that the listener has obtained from other sources and devices. For this reason, the user interface for the personal music collection preferably integrates digital music content already owned by the listener and available on other network-connected devices.

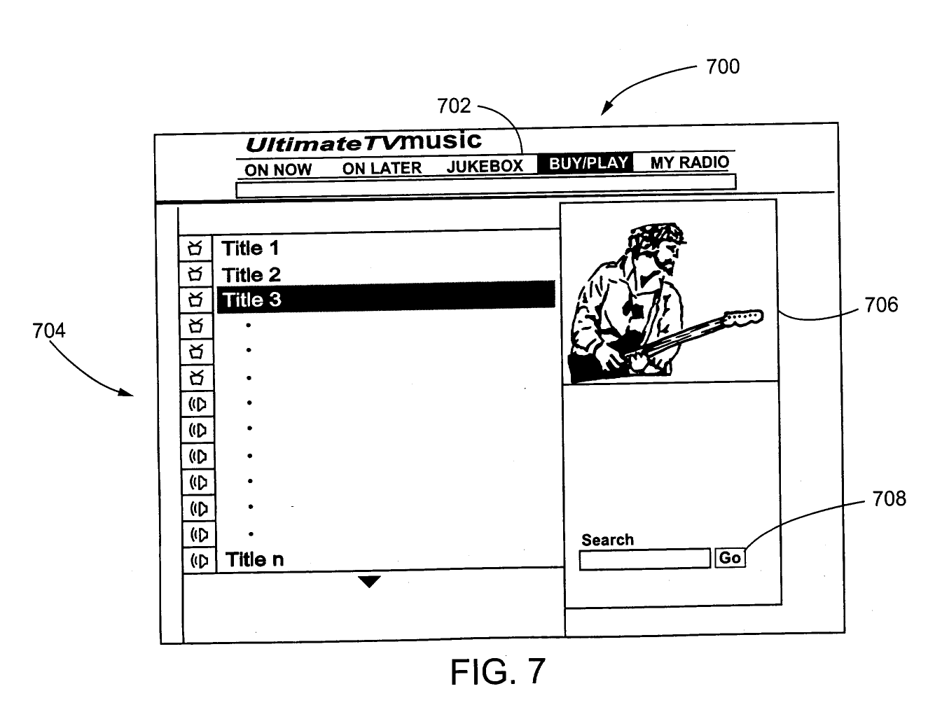

FIG. 7 illustrates a personalized Music Collection UI 700. This UI is accessed through a coarse navigation bar 702 provided with the interface. The Music Collection interface includes a play-list display area 704 that contains the items purchased by the listener as well as those contained on other devices, such as on the hard drive of a PC connected via a network to the Client System. As with the Jukebox example, when the listener selects one of the items in the play-list, the system plays back the corresponding music track from storage, either obtained locally from the Client System or from some other device via a network connection. Other information concerning the item currently being played back, such as album artwork or the like, may be provided in a display area 706. As with the Jukebox UI, the Music Collection UI may include a search tool, shown in a display area 708, to permit the listener to access items in the play list that are not currently being displayed or even to search elsewhere for music items of interest.

There are several ways in which a listener may purchase a desired title. When the listener selects a Buy button, a commerce partner could facilitate the transaction through an authentication mechanism such as a Single Sign-In (SSI) service for Internet users that provides identity management and authentication. In this embodiment, the Client System actually locates an Internet site to facilitate the transaction. Alternatively, a listener could “buy” the music title or other item by storing the track on his or her local music cache. The service maintains a record of the transaction and charges the listener accordingly. In this example, if the user desires to keep downloaded and stored music item(s), the set-top box could operate to create a record of the selected music item. The set-top box then communicates with the Music Server through the back-channel to complete the transaction. The service could then record the transaction and create an itemized charge as part of the service.

This arrangement provides an additional security features as compared to digital copies that are distributed via the Internet. That is, because it is delivered over a secure satellite connection, and stored on an encrypted disk in a closed software environment, the delivered music content does not require additional digital rights management encoding. Thus, the invention provides a secure content delivery mechanism.

Various advantages and features flow from the present invention. In other digital music content delivery systems, practical bandwidth considerations have prevented viable delivery mechanisms. Also, such services were not associated with other entertainment systems to attract their use, such as television and home entertainment systems. Finally, as noted above, the present invention provides a secure solution to digital music content delivery.

Accordingly, an enhanced digital music content delivery service that overcomes the deficiencies of the prior art has been described. It should be understood, however, that the foregoing description has been limited to the presently contemplated preferred embodiments for practicing the invention. It will be apparent that various modifications may be made to the invention, and that some or all of the advantages of the invention may be obtained. Also, the invention is not intended to require each of the above-described features and aspects or combinations thereof. In many instances, certain features and aspects are not essential for practicing other features and aspects. The invention should only be limited by the appended claims and equivalents thereof, since the claims are intended to cover other variations and modifications even though not within their literal scope and not specifically described in the patent specification.

What is claimed is:

1. A method for processing digital music content by a set-top box configured to receive broadcast television programming comprising the steps of:
receiving broadcast music content via the same broadcast media as the television programming;
receiving one or more user preferences provided a user;
filtering the received broadcast music content in accordance with the user preferences;
playing back the filtered broadcast music content; and
presenting a user interface concerning the playing digital music content on a video display.

2. The invention as in claim 1 wherein the user preferences relate to a music genre.

3. The invention as in claim 1 wherein the user preferences relate to an artist.

4. The invention as in claim 2 further including the steps of:
receiving a plurality of commercial offerings relating to the broadcast digital music content;
filtering the commercial offerings in accordance with the received user preferences; and
presenting information concerning the commercial offering on the video display.

5. The invention as in claim 4 wherein the video display is a television receiver.

6. A Digital Music Jukebox implemented as a computer program product capable of executing on a processor-based device as a method that performs the following steps:
receiving a plurality of broadcast music programs, each of the plurality of television programs including a tagged ID;
receiving one or more user preferences concerning a particular criteria for selecting the broadcast music programs;
filtering the received broadcast music programs in accordance with the particular criteria;
storing the filtered music content;
presenting, on a video display, a listing including a series of visual cues based on the tagged IDs, each of the visual cues corresponding to a currently available music offering stored on the client system storage media;

7. A method for playing back music content provided to a client system as a broadcast stream comprising the steps of:
receiving a digital music content stream via a broadcast media, the digital music content stream including a plurality of music titles each including an associated tagged identifier;
receiving user preferences according to a criteria;
storing a subset of the received digital music content stream on a storage media; and
presenting the subset of digital music content.

8. The invention as in claim 7 wherein the digital music content stream is received via a digital broadcast satellite network.

9. The invention as in claim 8 further including presenting an indication of the currently playing music title.

10. The invention as in claim 7 further including the steps of:
receiving a plurality of commercial offerings relating to the broadcast digital music content;
filtering the commercial offerings in accordance with the received user preferences; and
presenting information concerning the commercial offering on the video display.

11. A method for creating a personalized music collection provided to a client system comprising the steps of:
receiving digital music content via a broadcast media, the digital music content including a plurality of music titles each including an associated tagged identifier;
receiving user selections of one or more of the music titles;
storing the selections on a storage media; and
presenting a listing of the stored digital music content.

12. The invention as in claim 11 wherein the digital music content stream is received via a digital broadcast satellite network.

13. The invention as in claim 12 further including presenting an indication of the currently playing music title.

14. The invention as in claim 11 further including the steps of:
receiving a plurality of commercial offerings relating to the broadcast digital music content;
filtering the commercial offerings in accordance with the received user preferences; and
presenting information concerning the commercial offering on the video display.
